(19) United States
(12) Patent Application Publication
(10) Pub. No.: US 2011/0182660 A1
(43) Pub. Date: Jul. 28, 2011

(54) Shaft/Hub Connection and Manually Guided Implement

(76) Inventors: Ralf-Rainer Kemmler, Schwaikheim (DE); Eberhard Bohnaker, Leutenbach (DE)

(21) Appl. No.: 13/082,266

(22) Filed: Apr. 7, 2011

Related U.S. Application Data
(63) Continuation-in-part of application No. 12/177,397, filed on Jul. 22, 2008.

(30) Foreign Application Priority Data
Jul. 27, 2007 (DE) 10 2007 035 337.7

(51) Int. Cl. F16D 1/06; F16D 1/00

(52) U.S. Cl. 403/376; 403/345

(57) ABSTRACT

A shaft/hub connection between a shaft rotatably driven about an axis of rotation, and a hub disposed on the shaft so as to be non-rotatable relative thereto. The hub has a conical opening and an end face at that end of the hub having the greatest inner diameter. The hub also has at least one relief groove that extends into the hub from the end face thereof. A conical shaft extension on the shaft extends into the conical opening of the hub and is held in the hub via a conical pressure connection.

The instant application is a Continuation-In-Part application of Ser. No. 12/177,397 filed Jul. 22, 2008 and should also be granted the priority date of Jul. 27, 2007 the filing date of the corresponding German patent application DE 10 2007 035 37.7.

### BACKGROUND OF THE INVENTION

The present invention relates to a shaft/hub connection between a shaft that is rotatably driven about an axis of rotation, and a hub component that is disposed on the shaft so as to be non-rotatable relative thereto.

With manually guided implements, such as power saws, cut-off machines, or the like, it is known to dispose a flywheel on the crankshaft via a conical pressure connection. During operation, high dynamic stresses are superimposed over the static base load of the flywheel hub. This can lead to a shortening of the service life of the flywheel.

It is an object of the present application to provide a shaft/hub connection of the aforementioned general type that has a long service life.

### BRIEF DESCRIPTION OF THE DRAWINGS

These and other objects and advantages of the present application will appear more clearly from the following specification in conjunction with the accompanying schematic drawings, in which:

FIG. 1 shows a side view of a power saw;

FIG. 2 is a sectional view through the power saw of FIG. 1;

FIG. 3 is a perspective illustration of the crankshaft of the power saw of FIG. 1 with a clutch and a flywheel disposed thereon;

FIGS. 4 & 5 are cross-sectional views of embodiments of the flywheel hub;

FIG. 6 is a perspective cross-sectional illustration of the flywheel hub of FIG. 5;

FIG. 7 is a cross-sectional view of another embodiment of the flywheel hub; and

FIG. 8 is a partial cross-sectional view of a further exemplary embodiment of the flywheel hub.

### SUMMARY OF THE INVENTION

The present application provides a shaft/hub connection that comprises a shaft adapted to be rotatably driven about an axis of rotation; a hub disposed on the shaft so as to be non-rotatable relative thereto; wherein the hub has a conical opening and an end face at that end of the hub having the greatest inner diameter, and wherein the hub has at least one relief groove that extends into the hub from its end face; and a conical shaft extension provided on the shaft, wherein the shaft extension extends into the conical opening of the hub and is held in the hub via a conical pressure connection.

It has been shown that the static stresses can be reduced by a massive or bulky design of the hub. In this connection, however, the stresses that occur during the dynamic operation simultaneously increase. A massive design of the hub does not necessarily lead to a longer service life. It has been shown that the service life is lengthened if stress-relieving or antifatigue means are provided that reduce the dynamic fatigue stresses that occur during operation. As a result, with a hub having adequate static strength the dynamic stresses can also be reduced, resulting on the whole in a longer service life.

To reduce the dynamic fatigue stresses, the hub is provided with at least one relief groove. This relief groove reduces the rigidity of the hub in the region of the greatest inner diameter. Consequently, the dynamic fatigue stresses can be reduced. Due to the fact that a rim of the hub remains radially outwardly of the relief groove, the static fatigue stresses can at the same time be kept adequately low. The relief groove extends into the hub component from that end face of the hub that has the greatest inner diameter.

The relief groove expediently extends precisely or approximately parallel to the axis of rotation of the shaft. This results in favorable stress distributions. In this connection, the relief groove advantageously extends about the opening in a circular arc-shaped manner at least along a portion of the periphery of the opening. A plurality of relief grooves embodied as circular arc segments can be provided. A uniform stress relief can be achieved if the relief groove extends over the entire periphery of the opening.

The relief groove advantageously has a depth, as measured parallel to the axis of rotation, that corresponds to approximately 5% to approximately 25% of the greatest diameter of the shaft extension. In the radial direction, the relief groove advantageously has a width that corresponds to approximately 3% to approximately 20% of the greatest diameter of the shaft extension.

To reduce the dynamic fatigue stresses, the hub can be extended beyond the conical shaft extension on that side that has the maximum inner diameter, thereby forming an extension. In this connection, the opening of the hub advantageously also extends conically in the region of the hub extension. A conical annular gap thus results between the extension of the hub and the shaft. In the extending region, no forces are introduced into the hub, so that this region serves for reinforcement. Consequently, the dynamic stresses can be reduced. The extension advantageously has an axial length that corresponds to approximately 10% to approximately 50% of the greatest diameter of the shaft extension. The axial length of the extension is advantageously more than 20% of the greatest diameter of the shaft extension.

The length of the hub, measured in the direction of the axis of rotation, advantageously corresponds to approximately one half to approximately twice the maximum outer diameter of the hub in the region of the stress-relieving or antifatigue means. This enables an adequate strength of the hub.

In particular when providing an extension on the hub, a reduction of the outer diameter of the hub is provided. The maximum outer diameter of the hub in the region of the stress-relieving or antifatigue means expediently corresponds to less than approximately 190%, and especially less than approximately 175%, of the greatest diameter of the shaft extension. The outer diameter of the hub is reduced in comparison to known hub configurations. Consequently, the dynamic fatigue stresses that occur can be kept low. In this connection, the diameter of the hub in the region of the stress-relieving or antifatigue means, especially in the region of the extension, can decrease. In this connection, for example, a rounded-off or conical course of the outer diameter can be provided. The minimum outer diameter of the hub in the region of the stress-relieving or antifatigue means is advantageously less than approximately 175%, especially less than approximately 150%, of the greatest diameter of the shaft extension. The axial length of the shaft extension is expediently approximately 70% to approximately 150% of the greatest diameter of the shaft extension. To achieve a reliable connection of shaft and hub, the connection can be provided with means for a positive or interlocking securement of the position of rotation of hub and shaft relative to one another. The means for the positive securement can, for example, include an adjusting spring. Other means for the positive securement can also be advantageous.

The hub is advantageously formed at least partially in a bead of the flywheel. The greatest diameter of the bead is advantageously at least approximately 160% of the greatest diameter of the shaft extension. The axial length of the bead is advantageously approximately 30% of the greatest diameter of the shaft extension. This results in a good strength of the hub during operation, although the hub can have a low weight.

Further specific features of the present invention will be described in detail subsequently.

### DESCRIPTION OF SPECIFIC EMBODIMENTS

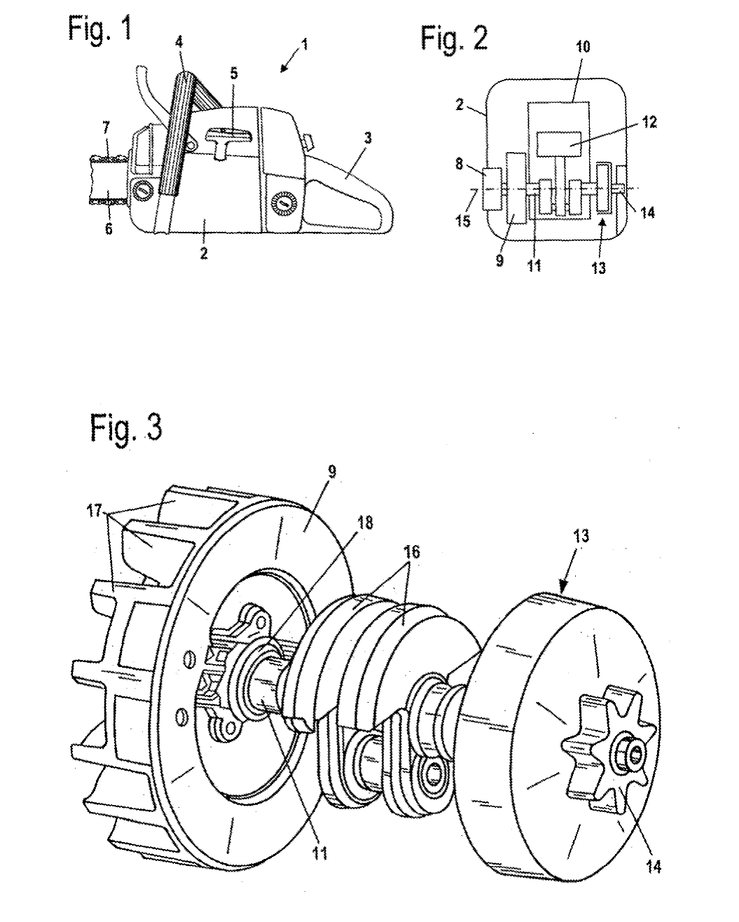

Referring now to the drawings in detail, the power saw 1, which is schematically shown in FIG. 1, has a housing 2 on which are secured a rear handle 3 and a tubular handle 4 for guiding the power saw 1. Extending from the housing 2 is a starter handle 5 for starting the drive motor of the power saw 1. Disposed on the power saw 1 is a guide bar 6 on which a saw chain 7 is driven in a circulating manner.

The saw chain 7 is driven by the driving pinion 14, which is shown in FIG. 2. The pinion 14 is connected via a centrifugal clutch 13 with a crankshaft 11 of an internal combustion engine 10 that is disposed in the housing 2. The internal combustion engine 10 is, in particular, a two-cycle engine or a mixture-lubricated four-cycle engine. The crankshaft 11 is driven in a rotating manner about an axis of rotation 15 by a piston 12 of the internal combustion engine 10.

On that side of the internal combustion engine 10 opposite the driving pinion 14 a flywheel 9 is secured to the crankshaft 11. Provided adjacent to the flywheel 9 is a starter device 8 that is actuated by the starter handle 5 and via which the crankshaft 11 can be set to rotate for starting the internal combustion engine 10.

As shown in the perspective illustration of FIG. 3, the crankshaft 11 has two crank webs 16. The flywheel 9 has a hub 18, via which the flywheel is secured to the crankshaft 11. The flywheel 9 is at the same time embodied as a fan wheel and has a plurality of vanes 17 for conveying cooling air.

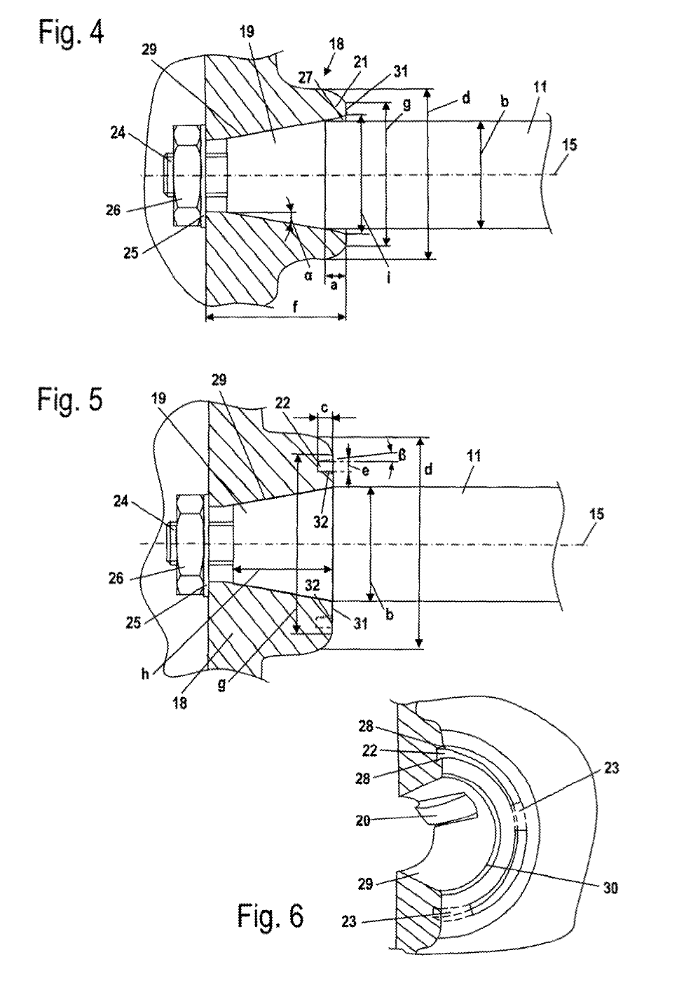

FIG. 4 shows the configuration of the hub 18 and of the crankshaft 11 in the vicinity of the hub 18. The crankshaft 11 has a shaft extension 19 that tapers out conically and on the end of which is disposed a threaded lug 24. The hub 18 has a conical opening 29 into which the shaft extension 19 extends. The cone angle α of the conical opening 29 corresponds to the cone angle α of the shaft extension 19. A washer 25 and a nut 26 are disposed on the threaded lug 24. The nut 26 is threaded onto the threaded lug 24 and via the washer 25 presses the hub 18 onto the shaft extension 19, so that the flywheel 9 is held on the shaft extension 19 via a conical pressure connection.

On that side facing away from the nut 26 the hub 18 has an extension 21. The extension 21 is thus disposed on that side of the hub 18 toward which the conical opening 29 widens. The extension 21 is disposed in the region of the greatest inner diameter i of the hub 18. The opening 29 also extends conically in the region of the extension 21. In the region of the extension 21, the crankshaft 11 is cylindrical, so that an annular gap 27 is formed between the crankshaft 11 and the extension 21 of the hub 18. The extension 21 has an axial length a, measured parallel to the axis of rotation 15, that is approximately 10% to approximately 50% of the greatest diameter b of the shaft extension 19. The greatest diameter b of the shaft extension 19 corresponds to the diameter of the crankshaft 11. The axial length a is advantageously at least approximately 20% of the greatest diameter b of the shaft extension 19.

In the region of the extension 21, the outer diameter of the hub 18 decreases toward an end face 31 of the hub 18. The end face 31 is that end face of the hub 18 that faces the crankshaft 11 and the internal combustion engine 10. In this connection, the outer surface of the hub 18 extends in a curved manner. However, this outer surface can also be provided with a conical path. The extension 21 has a maximum diameter d that is less than approximately 190%, and in particular less than approximately 175%, of the greatest diameter b of the shaft extension 19. Thus, the maximum outer diameter d is less than that of known hub configurations that have no extension 21. The minimum outer diameter g of the extension 21, which in the embodiment illustrated in FIG. 4 is disposed at the end face 31, is advantageously less than approximately 175%, and in particular less than approximately 150%, of the greatest diameter b of the shaft extension 19. The hub 18 has an overall length f, measured in the direction of the axis of rotation 15, that corresponds to about half to about twice the maximum outer diameter d of the hub 18 in the region of the extension 21. In this connection, the extension 21 extends from the greatest diameter b of the shaft extension 19, in other words from the region at which the shaft extension 19 merges into the crankshaft 11, to the end face 31.

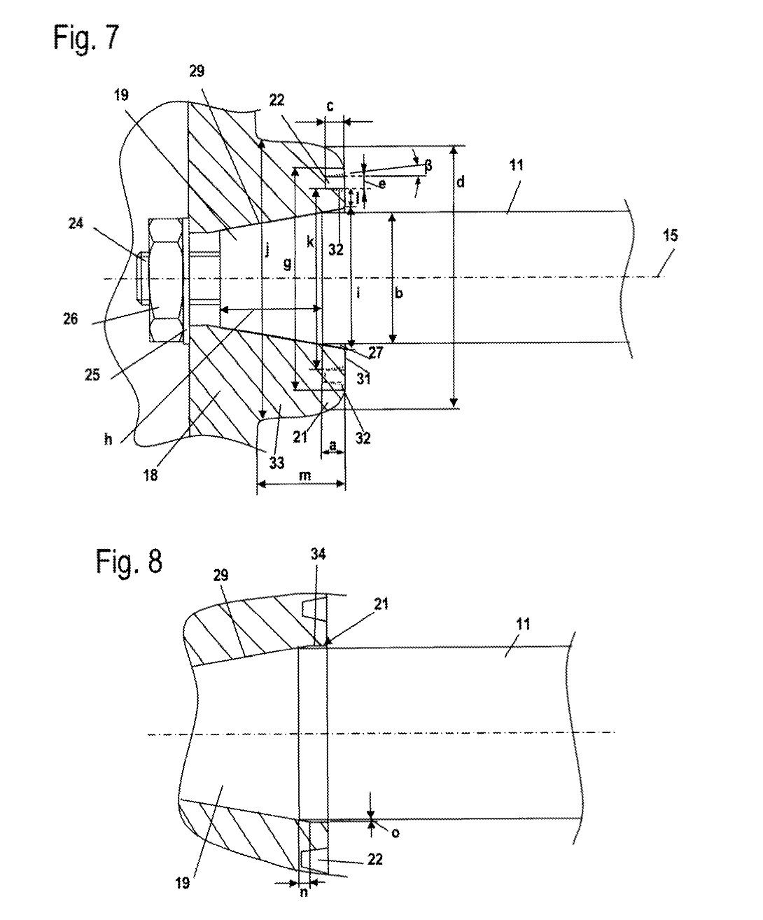

FIG. 5 shows a further embodiment of the configuration of the hub 18. With this embodiment, the end face 31 is provided with a relief groove or slot 22 which, as also shown in FIG. 6, is composed of four circular sectors that are separated from one another by ribs or similar elements 23. As indicated by dashed lines in FIGS. 5 and 6, the relief groove 22 can, however, also extend as a circular ring-shaped groove along the entire periphery of the opening 29. The relief groove 22 has a depth c, as measured parallel to the axis of rotation 15, that corresponds to approximately 5% to approximately 25% of the greatest diameter b of the shaft extension 19. The relief groove 22 has a width e, as measured in a radial direction relative to the axis of rotation 15, that corresponds to approximately 3% to approximately 20% of the greatest diameter b of the shaft extension 19. In the embodiment illustrated in FIG. 5, the shaft extension 19 ends at the end face 31 of the hub 18. However, it is also possible, in addition to the relief groove 22, that an extension 21 be provided on the hub 18 (see FIG. 7).

As shown in FIG. 5, the groove 22 extends parallel to the axis of rotation 15, so that the inwardly disposed side wall and the outwardly disposed side wall extend essentially parallel to the axis of rotation 15, The walls 28 (FIG. 6) may be respectively inclined in an opposite direction relative to the axis of rotation 15 by only a slight mold release angle β of approximately 2°. In this connection, the side walls 28 shown in FIG. 6, in other words the radially inwardly disposed and the radially outwardly disposed walls of the relief groove 22, extend angled to each other. As shown by the dashed line 32 in FIG. 5, only the radially inwardly disposed wall of the relief groove 22 can extend in the opposite direction relative to the radially outwardly disposed wall of the relief groove 22. In this connection, the angle of inclination can be small and is selected such that during manufacture in a casting process, the hub 18 can be released or removed from the mold in the direction of the axis of rotation 15. The radially outwardly disposed wall of the relief groove 22 also advantageously extends at an angle that corresponds at least to a mold removal angle. As shown in dashed lines in FIG. 5, the relief groove 22 respectively widens toward the end face 31 due to the opposite inclination of the side walls, which extend in the circumferential direction.

The maximum outer diameter d in the region of the relief groove 22 is measured at the level of the base of the relief groove 22. The minimum outer diameter g is also measured at the end face 31 in the embodiment of FIG. 5. In the region of the relief groove 22, the hub 18 extends in a curved manner from the maximum outer diameter d to the minimum outer diameter g.

The axial length h of the shaft extension 19 is less than the axial length f of the hub 18. The axial length of the shaft extension 19 is advantageously approximately 70% to approximately 150% of the greatest diameter b of the shaft extension 19.

As shown in FIG. 6, a bevel 30 is provided on that side of the conical opening 29 that faces the crankshaft 11. Formed on the hub 18 is a radially inwardly extending adjusting spring 20 that projects into a non-illustrated recessed portion on the shaft extension 19 and thus secures the shaft extension 19 in its position of rotation.

The extension 21 and the relief groove 22 serve for the reduction of the static and dynamic fatigue stresses on the hub 18 at that side that faces the crankshaft 11. In this connection, the extension 21 primarily effects a reduction of the static fatigue stresses, and the relief groove 32 predominantly effects a reduction of the dynamic fatigue stresses. It can be advantageous to combine these two stress relieving or antifatigue means with one another. It can also be advantageous to combine them with further antifatigue means or to provide other antifatigue means.

The combination of the extension 21 and of the relief groove 22 is shown in FIG. 7. By combining the extension 21 and the relief groove 22, it is possible to significantly reduce not only the static but also the dynamic fatigue stresses in the rotationally driven hub 18. In this connection, the configuration of the extension 21 and of the relief groove 22 corresponds to the configurations shown in the previously described embodiments.

As shown in FIG. 7, the length a of the extension 21 corresponds approximately to the depth c of the relief groove 22. The length a is advantageously approximately 80% to approximately 120% of the depth c. The relief groove 22 advantageously has an inner diameter k that is in the range of from approximately 110% to approximately 140% of the greatest diameter b of the shaft extension 19. The relief groove 22 thus extends about the conical opening of the hub 18 at a slight distance therefrom. The radial distance or spacing l between the conical opening 29 at the end face 31 and the relief groove 22 is advantageously approximately 5% to approximately 20% of the greatest diameter b of the shaft extension 19.

The hub 18 is partially formed in a bead 33 of the flywheel 9; it is embodied as an annular bead and extends in a direction toward the internal combustion engine 10. To achieve an adequate stability of the hub 18 despite the presence of the relief groove 22 in the hub, the greatest diameter j of the bead 33 is at least approximately 160% of the greatest diameter b of the shaft extension 19. In order not to unnecessarily increase the weight of the flywheel 9, the greatest diameter j of the bead 33 is no greater than approximately 250%, and in particular no greater than approximately 200%. Advantageously, the bead 33 has an axial length m that is at least approximately 30%, advantageously at least 50%, of the greatest diameter b of the shaft extension 19. The axial length m is advantageously no greater than the greatest diameter b. In this way, a favorable stress distribution can be achieved for the dynamic and the static fatigue stresses during operation, resulting in a long service life of the hub 18.

The embodiment illustrated in FIG. 8 is also provided with a relief groove 22 and an extension 21. However, in contrast to the embodiment shown in FIG. 7, the conical opening 29 is not extended in the same conical angle in the region of the extension 21. Rather, with the embodiment of FIG. 8 a cylindrical portion 34 adjoins the conical opening 29. To permit a reliable pressure of crankshaft 11 and hub 18, the opening in the hub 18 is extended slightly conically in the region of the extension 21, so that the cylindrical portion 34 has a small axial spacing n relative to the shaft extension 19, i.e. is slightly axially spaced from the shaft extension. Consequently, in the radial direction a small spacing o results between the crankshaft 11 and the cylindrical portion 34 of the hub 18.

The specification, which is a CIP application of Ser. No. 12/177,397, incorporates by reference the disclosure of U.S. patent application Ser. No. 12/177,397 filed Jul. 22, 2008 as well as the disclosure of German priority document DE 10 2007 035 337.7 filed Jul. 27, 2007.

The present invention is, of course, in no way restricted to the specific disclosure of the specification and drawings, but also encompasses any modifications within the scope of the appended claims.

What we claim is:

1. A shaft/hub connection, comprising:
a shaft that is adapted to be rotatably driven about an axis of rotation;
a hub disposed on said shaft so as to be non-rotatable relative to said shaft, wherein said hub has a conical opening and an end face at an end of said hub having the greatest inner diameter, and wherein said hub has at least one relief groove that extends into said hub from said end face thereof; and
a conical shaft extension provided on said shaft, wherein said shaft extension extends into said conical opening of said hub and is held in said hub via a conical pressure connection.

2. A shaft/hub connection according to claim 1, wherein said relief groove extends approximately parallel to an axis of rotation of said hub.

3. A shaft/hub connection according to claim 1, wherein said relief groove extends about said conical opening of said hub in a circular arc-shaped manner at least along a portion of a periphery of said opening.

4. A shaft/hub connection according to claim 3, wherein said relief groove extends over the entire periphery of said conical opening.

5. A shaft/hub connection according to claim 1, wherein said relief groove has a depth, as measured parallel to an axis of rotation of said hub, that corresponds to approximately 5% to approximately 25% of a greatest diameter of said shaft extension.

6. A shaft/hub connection according to claim 1, wherein said relief groove has a width, as measured in a radial direction relative to an axis of rotation of said hub, that corresponds to approximately 3% to approximately 20% of a greatest diameter of said shaft extension.

7. A shaft/hub connection according to claim 1, wherein at that end having the greatest inner diameter, said hub is extended beyond said conical shaft extension to form an extension.

8. A shaft/hub connection according to claim 7, wherein said conical opening of said hub also extends conically in the region of said extension of said hub.

9. A shaft/hub connection according to claim 8, wherein an annular gap is formed between said extension of said hub and said shaft.

10. A shaft/hub connection according to claim 7, wherein said extension of said hub has an axial length that corresponds to approximately 10% to approximately 50% of a greatest diameter of said shaft extension.

11. A shaft/hub connection according to claim 1, wherein a length of said hub, as measured in the direction of said axis of rotation, corresponds to approximately one half to approximately twice the maximum outer diameter of said hub in the region of said at least one relief groove.

12. A shaft/hub connection according to claim 1, wherein a maximum outer diameter of said hub in the region of said at least one relief groove corresponds to less than approximately 190% of a greatest diameter of said shaft extension.

13. A shaft/hub connection according to claim 12, wherein the maximum outer diameter of said hub in the region of said at least one relief groove corresponds to less than approximately 175% of the greatest diameter of said shaft extension.

14. A shaft/hub connection according to claim 1, wherein a minimum outer diameter of said hub in the region of said at least one relief groove corresponds to less than approximately 175% of a greatest diameter of said shaft extension.

15. A shaft/hub connection according to claim 14, wherein the minimum outer diameter of said hub in the region of said at least one relief groove corresponds to less than approximately 150% of the greatest diameter of said shaft extension.

16. A shaft/hub connection according to claim 1, wherein the connection is provided with means for a positive or interlocking securement of a position of rotation of said hub and said shaft relative to one another.

17. A shaft/hub connection according to claim 1, wherein said hub is at least partially formed in a bead of a hub component.

18. A shaft/hub connection according to claim 17, wherein said bead has a greatest diameter that is at least approximately 160% of a greatest diameter of said shaft extension.

19. A shaft/hub connection according to claim 17, wherein said bead has an axial length that is at least approximately 30% of a greatest diameter of said shaft extension.
